(19) United States
(12) Patent Application Publication
(10) Pub. No.: US 2008/0271723 A1
(43) Pub. Date: Nov. 6, 2008

(54) Anti global warming energy power system and method

(76) Inventor: Ralph A. Cowden, Honolulu, HI (US)

Correspondence Address: MCDERMOTT, WILL & EMERY, 4370 LA JOLLA VILLAGE DRIVE, SUITE 700, SAN DIEGO, CA, 92122, US

(21) Appl. No.: 11/473,579

(22) Filed: Jun. 22, 2006

Related U.S. Application Data
(60) Provisional application No. 60/800,856, filed on May 17, 2006.

(51) Int. Cl. F02P 3/00; H01B 7/00

(52) U.S. Cl. 123/594; 29/888.011; 174/126.2

(57) ABSTRACT

A piezo-ceramic device is attached to the power wire of an engine to facilitate cleaner burning of fuel and improve to improve fuel consumption. In the presence of an electrical field around the power wire, the device directs acoustical energy of a subsonic frequency towards the combustion chamber which acts to ionize the fuel and impart a thrust on the piston.

### RELATED APPLICATIONS

The present application claims priority to U.S. Provisional Patent Application Ser. No. 60/800,856 entitled “Anti Global Warming Energy Power System and Method,” filed May 17, 2006, the disclosure of which is incorporated herein by reference in its entirety.

### FIELD OF THE INVENTION

The present invention relates to internal combustion engines. The present invention has particular applicability to spark-ignition engines having spark plug wires, glow plug wires, internal spark plugs and external spark plugs.

### BACKGROUND ART

Conventional spark-ignition internal combustion engines are generally inefficient, and thus costly to operate due to the cost of fuel. Furthermore, they emit pollutants that adversely impact health and the environment, including greenhouse gases, which contribute to global warming. Still further, they emit other pollutants which have been linked to human health problems and environmental problems such as smog, and require complex and costly equipment, such as catalytic converters, to control.

There exists a need for an apparatus and methodology for increasing the fuel efficiency of internal combustion engines. There also exists a need for an apparatus and methodology for reducing the greenhouse gases and other emissions from internal combustion engines.

### SUMMARY OF THE INVENTION

To reduce the effects of global warming and reduce the need for gasoline/liquid/fossil fuel, the invention connects an anti-global warming energy power system (AGWEPS) device to an external spark plug wire, or to the wires connecting to an internal spark plug, of an internal combustion engine as close as possible to the spark plug boot at the spark plug. When the engine is started, the spark (of energy) travels past the AGWEPS and to the spark plug and ignites the fuel, while the AGWEPS provides what is believed to be dipolar ionization of the fuel and a tremendous power push upon the pistons. As a result, very little fuel is consumed and the fuel burns essentially clean. The AGWEPS may be attached to each of the spark plug wires of the engine and its cylinders. The spark traveling along the spark plug wire goes past the AGWEPS material, creating a tremendous power thrust that is sent down the spark plug wire(s), through the spark plug(s) and into the combustion chamber(s). The piston(s) is(are) pushed upon with tremendous energy/force, and the apparent dipolar ionization of the fuel causes the fuel to burn at a faster rate. As a result, there is a major reduction in the amount of fuel used by the engine(s), and the fuel burns essentially clean, with little or no fumes.

An advantage of the present invention is a method and apparatus for increasing the horse power and fuel mileage of an engine, and causing the fuel to burn clean (almost without fumes), to reduce air pollutant emissions that adversely impact health and the environment and fight global warming. The wide spread use of the inventive methodology will mean vehicles and other engines will demonstrate more power and efficiency, use less fuel, and almost eliminate the emissions of any kind into the atmosphere. The inventive method increases the horsepower and/or torque due to the creation of energy by what is believed to be dipolar ionization of the fuel, the clean burning of the fuel, and the increased power output by the engine. An immense power thrust results when the spark passes the AGWEPS and then travels down the spark plug wire, through the spark plug, and into the engine, igniting the fuel and pushing upon the pistons. There also appears to be a larger explosion of the fuel at a cooler temperature, as well as ionization of the fuel which results in the emission of far less fumes. Thus, the AGWEPS initially helps to initiate a major release of power upon the piston(s), while the spark is igniting the fuel. The effect of the use of the AGWEPS is a major reduction of the amount of fuel needed to get the engine started and then for it to stay running (and also to help power the vehicle to move up to full speed, regardless of its weight and size) and essentially clean burning of the fuel, with the emission of far less fumes.

Additional advantages of the present invention will become readily apparent to those skilled in this art from the following detailed description, wherein only an exemplary embodiment of the present invention is shown and described, simply by way of illustration of the best mode contemplated for carrying out the present invention. As will be realized, the present invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIG. 1 is a side view of an ignition system incorporating an AGWEPS according to an embodiment of the present invention.

FIG. 2 is a side view of an AGWEPS attached to a spark plug wire.

FIG. 3 is another view of the ignition system of FIG. 1.

FIGS. 4A-4C illustrate different embodiments of an AGWEPS device including a diode.

FIG. 5 depicts a power wire of an engine on which multiple AGWEPS devices have been installed in accordance with the principles of the present invention.

### DESCRIPTION OF THE INVENTION

Conventional spark-ignition internal combustion engines are generally inefficient, and thus costly to operate. Furthermore, they emit greenhouse gases and other pollutants, which contribute to global warming and human health problems. The present invention addresses and solves these problems stemming from conventional engines. Although vehicle engines are discussed in detail below and, more specifically, engines having spark plugs, the various embodiments of the present invention are not limited to these exemplary uses of the AGWEPS device. For example, the AGWEPS device may prove beneficial in an engine of a watercraft, a jet engine of an aircraft, an engine of lawn mowers and other agricultural equipment, and in fuel-powered generators. Furthermore, as discussed in more detail below, the AGWEPS device operates with spark-ignition engines as well engines such as diesel engines that operate using a glow plug.

As meant herein, a power wire of an internal combustion engine includes any wire that directs electrical energy towards a combustion chamber of the engine. For example, in a typical gasoline multi-cylinder engine, each cylinder has a respective ignition wire that carries the electrical energy to a spark plug. This is true whether the engine has a conventional distribution or includes an electronic ignition. In the case of a diesel engine, there is a power wire that carries electrical current to a respective glow plug for each cylinder. In the case of coil-over-plug configurations, there are two power wires (typically red in color) and the AGWEPS may be attached to either one of these power wires. Furthermore, there are typically other components between the source of electrical energy and the combustion chamber. These components may, for example, include the boot of the spark plug wire, an adaptive fitting between the spark plug (or glow plug) and the power wire, and also, the spark plug, or glow plug, itself. The AGWEPS may be located anywhere between the electrical energy source and the combustion chamber and, therefore, the term “power wire” is meant to also encompass any component in this region in addition to conventional wires. Thus, the use of the term “spark plug wire” in specific examples described herein is not meant to limit the applicability of the AGWEPS device to only those engines described.

In general, the invention relates to a methodology for using less fuel in engines while increasing power by what is believed to be dipolar ionization of the fuel. Dipolar ionization of fuel results in strong energy and an electrical power system/power push, whereby each of the engine's pistons are pushed upon by this very strong force, and there is consequently a much reduced level of fuel consumption. The fuel is believed to be dipolar ionized by the AGWEPS device, and essentially burns clean. As the spark travels down the spark plug wire to the spark plug, it passes the AGWEPS device, and as it passes there is a release (or thrust) of a tremendous additional amount of power, which is sent or carried into the spark plug and pushes the piston. A single AGWEPS can be used for each spark plug, or a plurality of AGWEPS can be used, without limitation. In one embodiment of the present invention, good results have been achieved using two AGWEPS on each spark plug wire, for internal or external spark plugs or glow plugs. The effect resembles two strong magnets pushing away from each other as their positive sides are pushed together. This major pushing power is readily apparent and felt. The electro-mag-subsonic frequency arising from the AGWEPS tremendously increases the thrust/power brought to bear on the piston(s). It follows the path of the spark plug wire into the spark plug and into the engine's combustion chamber, and pushes the piston(s) backwards to cause a quicker attainment of full power, while the spark from the spark plug is igniting the fuel. The sparking of the spark plug and the release and passing of the power arising from the AGWEPS′ apparent dipolar ionization of the fuel, is believed to result in the fuel exploding and burning in an essentially cooler, clean way. It is also believed that, in this way, emissions from the engine are significantly reduced because almost all the carbon of the fuel is burnt. The engine needs little fuel to cause full acceleration, and also achieves more power without having to push the gas pedal very much for the vehicle to get moving. Furthermore, there is a dramatic reduction in the amount of fumes, since the emissions are essentially clean. The overall impact of the inventive AGWEPS methodology is much cleaner emissions and a potentially tremendous favorable effect on the reduction of global warning, if the invention is used on a large-scale basis around the world. The result would be a major lowering of demand for fossil fuels. As used herein, the term “subsonic” refers to frequency of acoustical energy and not its propagation speed. Typically, subsonic frequencies are recognized as frequencies below 10 Hz.

According to the present invention, the inventive AGWEPS methodology is for use in engines with internal or external spark plugs, spark plug wires, pistons and cylinders, including hybrid power plants, which operate using gasoline, diesel fuel (via the engine's glow plugs), gas, coal, bio fuel and other types of fuels.

The AGWEPS methodology uses a device attached to a conventional spark plug wire. Ideally, it is placed next to a conventional spark plug boot on the spark plug wire. However, our research has shown placement of the device no more than five (5) inches from the spark plug itself has proven particularly effective, since the effect of the AGWEPS on power becomes weaker the further away from the spark plug boot and spark plug the material has been attached to the spark plug wire. The acceptable distance of the device's location will vary in accordance with the condition, operating specifications and characteristics and performance of different engines. How near the inventive device can be properly attached to the spark plug varies depending on the engine configuration, based on accessibility. A “+” or other marking on one end of the AGWEPS is aimed “away” from the spark plug boot and the spark plug itself. The AGWEPS may be attached by simply wrapping together the outside of the AGWEPS and the spark plug wire with black electrical tape, and covering the outer surface of the AGWEPS with the tape. Alternatively, the outside of the AGWEPS may be protectively coated, and the spark plug wire and the AGWEPS are then clamped together using any of a variety of known techniques. Another alternative includes the use of one or more straps or zip ties to attach an AGWEPS device to a power wire. The material of which the AGWEPS is comprised is a dipolar material such that the dipoles are aligned during its manufacture. Consequently, one end of the AGWEPS device is labeled with a “+” or some similar indicator.

In one preferable embodiment, the AGWEPS device comprises a dipolar material having the following physical/chemical characteristics and composition:

Max Temp. Significant 950 degree C.

Ceramic Powder fused to a certain pole shape; e.g., a solid cylindrical shape

Gravity N705 g/cc

Lead Oxide 1317-36-8 50-80% PEL 0.05 mg/m3 (as PB)

Zirconium Dioxide 7440-67-7 0-35% PEL 5 mg/m3 (as Zx) STEL 10 mg/m3

Titanium Dioxide 13463-67-7 0-30% PEL 15 mg/m3

Strontium Oxide 7440-24-6 0-10%

Organic Binders 0-2% Carbon Black Graphite

The above material is made into AGWEPS dipolar material for use in the inventive methodology using the following process:

Mix and roll the material out. It is desirable to heat the material, so it is made softer and easier to roll in a way very similar to the rolling of bread. The material is cut using a laser cutter and compressed to the desired shape.

2) Add carbon black graphite dipolar material to the material, and roll it out. The carbon black graphite creates a dipolar electrical material and also functions as a electromagnet when electricity is subsequently used to tune the fiber in the material.

3) Heat the material. The carbon black graphite will extrude from the material upon reaching a temperature of between 400 to 500 degrees C. The carbon black graphite acts as a binder to crystallize the material. Electricity is used during heating to activate and tune the dipolar material in a way that is similar to that of a computer being used to read frequencies.

4) After the material is crystallized, it is pounded so that the positive and negative is lined up. The material is then in its final form as the dipolar material called AGWEPS.

An example of AGWEPS material that can be used to practice the invention is a model EC64 Slug manufactured by EDO of Salt Lake City, Utah. However, while the EC64 Slug was used for convenience, the invention can be independently made from raw materials to suit the individual needs of the user. One exemplary slug has a length of approximately 0.736 inches with an outside diameter of approximately 0.590 inches although other dimensions are contemplated as well.

In certain embodiments of the invention, described later, a diode may be included internal to or external to the AGWEPS device for cooling the AGWEPS device and for directing the energy in a single direction. In the internal diode embodiment, the diode is inserted into the AGWEPS material while it is cooling down and the material is still soft enough to allow insertion of the diode and reshaping of the AGWEPS after step 4 above. In further embodiments of the present invention, an additional diode may be attached to the outside of the AGWEPS device. By forming electrodes on each end of the AGWEPS device that are electrically connected with the diodes, the AGWEPS can be used to create a supply of electricity. The electrodes, such as electrodes comprising silver, enable power to be extracted from the device. The availability of the electrodes also provides a way to test the installation of an AGWEPS device once it is installed on a power wire of an engine. In the case of a typical gasoline V-8 engine, the voltage across the AGWEPS device while the engine provides an indication of whether or not the device is properly installed. Treating the end of the AGWEPS device furthest from the spark plug as the positive terminal, a volt meter will indicate about +500 mV or more across the two ends of the AGWEPS device. A lower voltage reading than this indicates the device is installed improperly or, possibly defective.

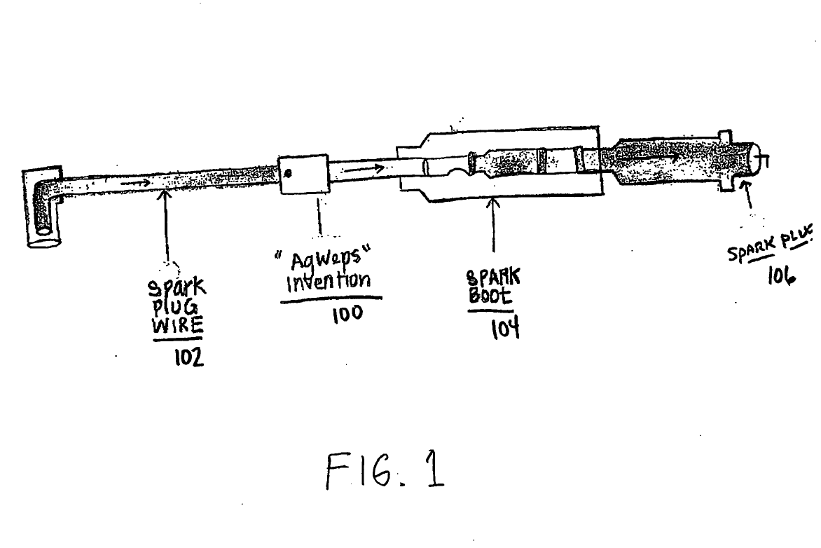

The inventive method using an AGWEPS will now be described with reference to FIGS. 1-5. FIG. 1 shows the AGWEPS device 100 attached to a conventional spark plug wire 102 or some other power wire of the engine as described earlier. The AGWEPS 100 is preferably located within five inches of the spark plug 106, and should be as near as possible to where the spark plug boot 104 and the spark plug 106 meet on the spark plug wire 102. The spark (see arrows) in the spark plug wire 102 always travels towards the spark plug 106 and past the AGWEPS 100. The spark plug boot 104 for each of the engine's cylinders provides protection at the point where the spark plug 106 and the spark plug wire 102 come together. The spark plug 106 receives/accepts the spark that has traveled along the spark plug wire 102 and ignites the fuel in the cylinder's combustion chamber.

The AGWEPS 100 is connected to the spark plug wire 102 by zip ties, space-industry PVC, clamps, or wrapping electrical tape to hold the spark plug wire 102 and the AGWEPS 100 together, or by any other functionally equivalent meant for attaching the AGWEPS 100 external of the spark plug wire 102. Such as, for example, they may be held together by one or more clamps. A marking (such as a “+”) on one end of the AGWEPS 100 should be aimed or directed away from the spark plug boot 104 and the spark plug 106. The energy power push (308, see FIG. 3) travels down the spark plug wire 102, then to and through the spark plug boot 104, and then to and through the spark plug 106. It then enters and energizes the combustion chamber and pushes the piston downwards in the cylinder with tremendous energy and power in the form of a electro-mag-subsonic frequency force. The inclusion of the term “mag” in describing this acoustical energy is not intended to explain the method of operation of the AGWEPS in terms of magnets but, instead, merely recognizes that current through a conductor inherently creates an electro-magnetic field which the AGWEPS device experiences due to its attachment to the power wire. The AGWEPS device does not become magnetic nor does it act like a magnet nor does it direct magnetic forces. The subsonic force, or acoustical energy, provided by the AGWEPS is in response to the field around the electrical conductor near the AGWEPS device which has both an electrical component and a magnetic component. The terms “electrical” and “magnetic” are simply the terms that have conventionally been used to identify the orthogonal components of an energy field around a conductor through which current flows.

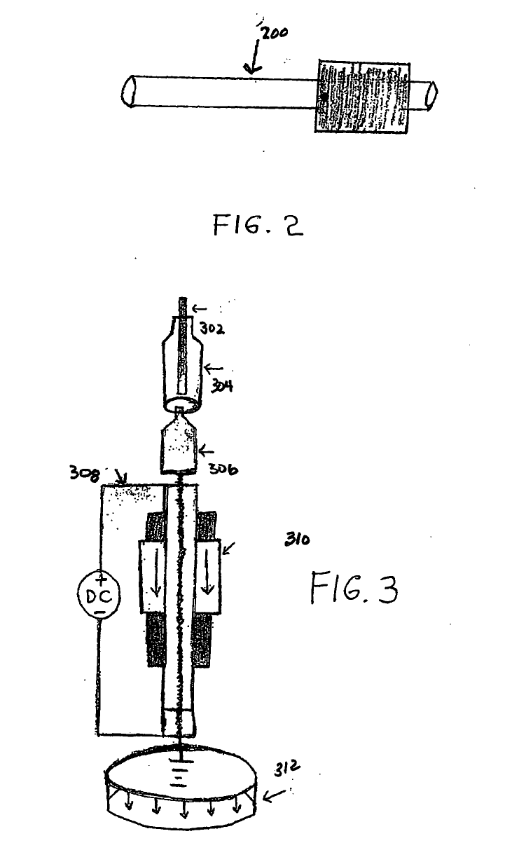

Reference symbol 200 in FIG. 2 shows the AGWEPS attached to a spark plug wire.

Reference symbol 308 in FIG. 3 shows the spark plug's location at the point where one of its ends enters the engine's combustion chamber, where the apparent electro-mag-subsonic force of power has passed, and the pushing force reaches the pistons, while the fuel is being ignited. The size of the explosion of the fuel at that time is increased as a result of what is believed to be the electro-mag-subsonic frequency power thrust and ionization of the fuel. Not only is less fuel is burned, but there are very little emissions resulting from burning of the fuel; specifically, there has been seen a very significant reduction in carbon compound emissions. When activated by an electric field the molecules in the crystal structure of the AGWEPS device become polarized and therefore active in the electric field. The AGWEPS thereby plays a direct part in the production of an electric field, whereby the material's dimensions are also altered as a result. There is a forceful mechanical, pushing effect, and an amplification of the energy/power occurs, whereby the piston(s) is(are) pushed downwards in the cylinder(s).

Referring again to 308 in FIG. 3, reference symbol 302 is the spark plug wire, 304 is the spark plug boot, 306 is the spark plug, 310 is the energy/power with the electrical spark in the chamber, and 312 is the cylinder head/piston.

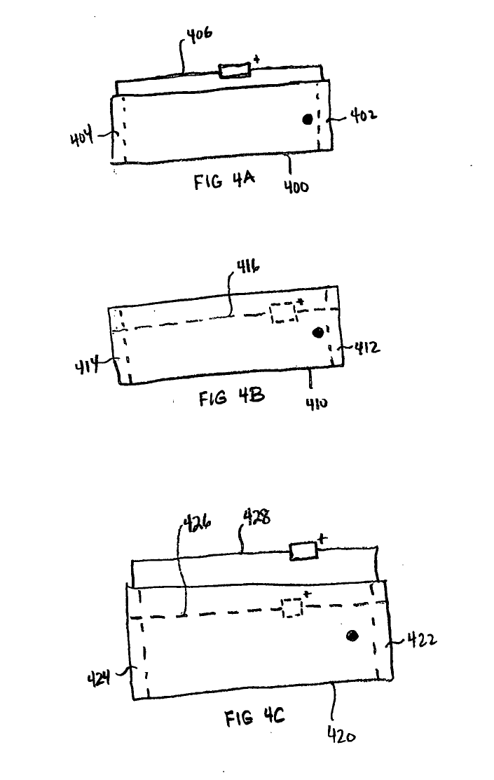

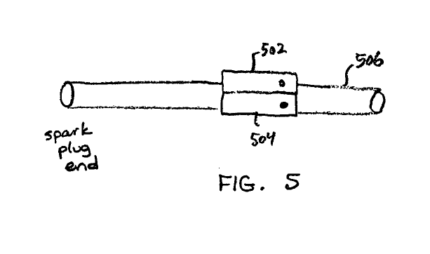

FIGS. 4A-4C depict three different embodiments of the present invention. In particular, the AGWEPS device may include one or more diodes coupled across its ends as shown in the figures. In FIG. 4A, the AGWEPS device 400 includes respective electrodes 402, 404 at each end of the device. These electrodes may be formed during the manufacture of the AGWEPS device 400 or added during a later manufacturing process. A diode 406 is attached so that respective terminals of the diode 406 attach to each of the electrode areas 402, 404. As shown the polarity, of the diode mimics that of the AGWEPS device 400 such the positive terminal of the diode is furthest from the spark plug when the AGWEPS device is installed in an engine.

The device of FIG. 4B depicts an internal diode 416 that installed within the AGWEPS device 410 and connected to electrode regions 412, 414. As mentioned earlier, the diode 416 may be embedded in the AGWEPS device 410 during a phase of the manufacturing process in which the AGWEPS material is soft. The AGWEPS device 420 of FIG. 4C includes both an internal diode 426 and an external diode coupled across electrode regions 424 and 422.

FIG. 5 depicts an installation of more than one AGWEPS device 520, 504 on a single power wire of an engine. Although only two AGWEPS devices 502, 504 are shown even more devices may be attached side-by-side if desired. The shape of the AGWEPS device may vary to facilitate placement of it outside the power wire. For example, a rectangular block shop may be used or a cylindrical plug-like shape may be used as well. Furthermore, one surface may be machined or shaped to conform to the curvature of the power wire. In general, the shape of the AGWEPS device described herein may be modified in a variety of ways without departing from the scope of the present invention.

In the case of multi-cylinder engines, an AGWEPS device may be installed on the power wire for one cylinder, the respective power wires for a number of cylinders, or the respective power wires for all cylinders. However, testing of the device has identified some configurations that have proven particularly effective. For example, in V-10 engines an AGWEPS device on the power wires for cylinders 1, 3, 6 and 8 has proven effective. In many V-8 engines, one AGWEPS device attached to the power wires for cylinders 1 and 6 has proven effective. In both I-6 and V-6 engines, one AGWEPS device on each power wire for cylinders 1 and 6 has proven effective. In I-4 and V-4 engines, one AGWEPS device on each power wire for cylinders 1 and 4 has proven effective.

Tests have been conducted to analyze the effectiveness of the inventive methodology. A summary of the results of some of the testing is provided herein as evidence of the effectiveness of the AGWEPS device to achieve its intended goals. The tests were conducted by Weber Motor Sports located at 6520 West Hammer Lane, Las Vegas, Nev. and were certified by Paul Weber the owner and test engineer for this facility. In these reports, the AGWEPS device is often referred to as an “Ag”, the “AGS” or the “Ags”.

Test Results 1:

Evaluation and Test Results: 2005 General Motors Hummer, 14,000 miles in all driving conditions. Vortec V/8. Installed 8 Ags, one per cylinder. Later found 8 was no gain over only 2 installed per the special installation bulletin on #1 and #6 cylinders. The result for 8 Ags was minimal, but with 2 Ags mounted per the bulletin was dramatic going from 13 MPG to 27 MPG, it also started and ran smoother and better.

Test Results 2:

Evaluation and Test Results: 1995 Ford Mustang, 5.0 V/8, 5 speed transmission, 120,000 miles on vehicle. Before installation 12 MPG, engine ran rough and had difficulty pulling hills. Installed 1 Ag. each On cylinders #1 an #6. MPG increased to 28 MPG, with more power and no roughness and tremendous acceleration.

Test Results 3:

Evaluation and Test Results: 1956 Chevy Pick-Up Street Rod, 350 Chevy engine, Auto, Air, Cruise, Power Steering and 4 wheel Disc Brakes.

Vehicle was hard to start, Lumbered in traffic with Air on and only made 9 MPG with Holley 4-Barrel Carburetor, Installed 2 Ags., One #1 cylinder and One on #6 cylinder. After only one week this Truck went to 24 MPG, starts easier, performs much better and seems to run so much better with less throttle applied.

Test Results 4:

Evaluation and Test Results: 1981 Chevrolet Corvette, 350 Cubic Inch displacement, Auto Trans. 92130 miles on Odometer, barely passed emissions test on May 10, 2006.

Installed 2 Ags. One on #1 cylinder and One on #6. Re-tested this vehicle again on May 19, 2006 and found is passed easily, ran smoother, with more performance and virtually no emissions.

Gas Mpg before 9, after installation 23.

Test Results 5:

Evaluation and Test Results: 2003 Chevrolet Corvette Coupe Z06, 6 Speed Trans 5,000 Miles. Mileage 19 Avr. Before. After installing 2 Ags in the previous manner mileage went to 34 MPG. With no Emissions and astounding power increase.

Test Results 6:

Evaluation and Test Results: 2002 Chrysler Sebring Convertible V/6. Installed two (2) Ags. Before installation 16 Miles Per Gallon All City and some Highway.

After Installing on cylinders #1 and #4, Mileage improved to 31 Miles Per Gallon, combination of City, Mountain and Highway driving. The engine ran easier, with less effort to the accelerator and UN-READABLE emissions on the V.I.R. report for registration renewal.

Test Results 7:

Evaluation and Test Results: 2004 Nissan Truck V/8 Auto and 4×4 Installed 2 Ags. on vehicle, One on. #1 cylinder and One on #6 cylinder. Before installation 12 MPG. After installation 21 MPG.

Test Results 8:

Evaluation and Test Results: 350 cubic inch Drag Racing Engine, Bored and Stroked to 383 Cubic Inch Displacement. Aluminum Heads, Roller Camshaft, 14½ to 1 Compression, Balance and Blueprinted with a Complete MSD Ignition. First Dyno Test without Ags. Installed at 6600 rpms 456.9 Ft pounds of torque and 574.2 horsepower. Installed 9 Ags. on the MSD 8 mm Race wires with no other changes. 1 on the coil wire and one on each Spark Plug Wire. Second test at 6500 rpm 491.3 ft pounds of Torque and 609.5 Horsepower.

Additional test results were collected by a second test organization, a summary of which is presented below in tabular format. First, a summary of the test methodology provided: On Friday May 19^{th}, and Saturday, Jun. 10 and Sunday, Jun. 11, 2006, Apex Performance, a Southern California based automotive marketing and performance driving company, provided a team of professional drivers in Irvine, Calif. to conduct fuel efficiency and emissions testing of the Anti-Global Warming Energy Power System (AGWEPS). The objective of these tests was to render impartial and objective observations regarding the effects AGWEPS had on fuel economy and emissions.

AGWEPS was tested on four vehicles that were chosen to represent a spectrum of classifications and engine types including compact, mid-size and SUV. AGWEPS was tested on four, five, and six-cylinder engines. Testing was conducted by driving the vehicles with and without the AGWEPS attached, duplicating the same driving conditions in each test drive. The drive without the AGWEPS is known as the “control” drive.

The drive route was 78.9 miles and took approximately two hours. In order to have accurate comparisons, the drive was structured to represent typical daily driving conditions including a combination of highway and residential roads where traffic flow fluctuated from light to heavy.

The vehicles were equipped with two-way radios and led by a pace car to help keep speeds and conditions consistent for all drivers and vehicles. Speed limits were obeyed at all times.

Overall fuel efficiency and emission results were recorded and are provided in detail further into this document.

Four vehicles were chosen to represent a spectrum of classifications and engine types. These included compact and mid-size coupes and sedans and an SUV. Engine sizes varied to include four, five and six-cylinders. The vehicles utilized for this testing were:
2005 Volkswagen Jetta
2.5 liter 5-cylinder automatic transmission
13,175 miles
2006 Nissan Altima
2.5 liter 4-cylinder automatic transmission
17,343 miles
2005 Chevrolet Cobalt
2.2 liter 4-cylinder automatic transmission
12,423 miles
2006 Nissan Murano
3.5 liter 6-cylinder automatic transmission
8,542 miles

The test methodology was devised to render accurate “real world” MPG measurements combining highway and residential driving over a 78.9 pre-planned route that took approximately two hours to cover. The vehicles were fueled and driven on the route twice, once with the AGWEPS attached, and once without—the “control” drive.

Altima and Jetta were tested twice under the same conditions on two separate dates—May 19^{th} for the initial test and June 10^{th}/11^{th} for the subsequent test. While the vehicles tested were the same model, trim level and engine size, the same vehicles (VINs) were not tested twice.

The test was conducted under the following conditions:
1 Apex drivers observed the installation and removal of the AGWEPS, yet were not instructed how to install the AGWEPS.
2 Apex drivers were not made familiar with the technical functionality of the AGWEPS nor the materials used in the construction of the device. If we were asked to identify, explain or apply the device, we would not be able to do so.
3 The drive route incorporated a variety of roadway conditions including varying elevations of small hills and steep grades, winding roads, stop-and-go traffic and highway driving at speeds averaging 60 mph.
4 The route was 78.9 miles long and GPS was used to verify the accuracy of miles traveled. The route was driven twice, with and without the AGWEPS attached.
5 Tire air pressure and vehicle fluids were inspected and adjusted to manufacturer's specifications.
6 When fueling, the pump was set to medium flow position to minimize fuel foam. When the pump clicked off, the tank was considered full and was not topped-off.
7 The same fuel pump was used for all vehicles.
8 The same octane fuel was used in all vehicles (87)
9 All vehicles were equipped with two-way radios, and were led by a pace car on the drive route. This was done to ensure that vehicles were all driven at an equal pace.
10 At the end of the drive route, vehicles were refueled in the above-mentioned manner and the amount of fuel consumed was recorded. The number of miles traveled was then divided by the amount of fuel consumed to determine the miles per gallon reading.
11 Emissions were measured by a California DMV certified emissions testing facility with and without the AGWEPS attached.
12 Weather conditions on the drives were identical on both drives: mid-70 degrees, humidity approximately 60%, and winds WSW between 8 and 10 mph.

Miles per Gallon Test Results:

| | | ERA | | MPG | |
|---|---|---|---|---|---|
| | Date | Estimated | MPG w/o | With | MPG % |
| Vehicle Tested | Tested | MPG* | AGWEPS | AGWEPS | Increase |
| 2005 Volkswagen Jetta (1) | 5/19 | 22 City/30 Hwy | 25.78 | 41.30 | 60.20% |
| 2005 Volkswagen Jetta (2) | 6/20-21 | 22 City/30 Hwy | 36.56 | 71.02 | 94.25% |
| 2006 Nissan Altima (1) | 5/19 | 24 City/31 Hwy | 30.39 | 56.35 | 85.42% |
| 2006 Nissan Altima (2) | 6/20-21 | 24 City/31 Hwy | 28.91 | 50.67 | 75.27% |
| 2006 Nissan Murano | 6/20-21 | 20 City/25 Hwy | 19.82 | 44.60 | 125.03% |
| 2005 Chevrolet Cobalt | 6/20-21 | 24 City/32 Hwy | 30.29 | 45.65 | 50.71% |
| | | Averages | 28.63 MPG | 51.60 MPG | 80.23% |

*Source: MPG as reported on manufacturer website.

Hydrocarbon Emissions Test Results:

| | | Hydrocarbons | Hydrocarbons | |
|---|---|---|---|---|
| | Date | w/o AGWEPS | w/AGWEPS | % |
| Vehicle Tested | Tested | (ppm) | (ppm) | Improvement |
| 2005 Volkswagen Jetta (1) | 5/19 | N/A** | N/A** | N/A** |
| 2005 Volkswagen Jetta (2) | 6/20-21 | 32 | 2 | 93.75% |
| 2006 Nissan Altima (1) | 5/19 | N/A** | N/A** | N/A** |
| 2006 Nissan Altima (2) | 6/20-21 | 21 | 1 | 95.23% |
| 2006 Nissan Murano | 6/20-21 | 34 | 2 | 94.12% |
| 2005 Chevrolet Cobalt | 6/20-21 | 22 | 2 | 90.90% |
| | Averages | 27.25 | 1.75 | 93.57% |

Carbon Monoxide Emissions Test Results:

| | | GO w/o | GO | |
|---|---|---|---|---|
| | Date | AGWEPS | w/AGWEPS | % |
| Vehicle Tested | Tested | (ppm) | (ppm) | Improvement |
| 2005 Volkswagen Jetta (1) | 5/19 | N/A** | N/A** | N/A** |
| 2005 Volkswagen Jetta (2) | 6/10-11 | .53 | .01 | 98.11% |
| 2006 Nissan Altima (1) | 5/19 | N/A** | N/A** | N/A** |
| 2006 Nissan Altima (2) | 6/10-11 | .51 | .01 | 98.04% |
| 2006 Nissan Murano | 6/10-11 | .51 | .08 | 84.31% |
| 2005 Chevrolet Cobalt | 6/10-11 | .51 | .01 | 98.04% |
| | Averages | .52 | .03 | 94.23% |

**The California “certified” testing facility was prematurely “closed” on 5/19 and emissions tests could not take place for the run “without the AGWEPS.” As a result, it was decided to test a vehicle of the same model and year and approximately the same mileage in the test on 6/10 and 6/11.

A separate test was conducted around Honolulu Hi. on June 2006. This test included a 1999 BMW 528i (6 CYLINDER with Internal Spark Plugs) and a 2004 VW JETTA (4 CYLINDER with external Spark Plugs). Each car underwent a substantially similar test involving: 1) Full Tank of Gas of 87 Octane; 2) Test Course Length of 100 Miles +/−; 3) A/C on during Test; 4) Night Driving; 5) 75 degree+/−Very Cool; 6) City Driving/Hwy Driving averaging around 35 mph; 7) Test Location: Honolulu, Hi.

Test Results:

### CAR #1 (1999 BMW 528I)(6 CYLINDER)

### Mileage: 58, 322

One AGWEPS on #1 and #6 Cylinder each
Driven 110 miles (Gas Replaced 2.46 Gallons)
This car averages (10-12 City)(18-20 Highway)

### (110 Miles) (2.46 Gallons)=44.71 MPG

### CAR #2 (2004 VW JETTA)(4 CYLINDER)

### Mileage: 28,592

One AGWEPS on #1 and #4 cylinder each
Driven 110 miles (Gas Replaced 1.97 Gallons)
This car averages (15-18 City)(20-24 Highway)

### (110 Miles) (2.21 Gallons)=49.78 MPG

Additional Testing in Honolulu with these two cars provided the following results:

Test Results 1:
VW JETTA 2004
Date: May 28, 2006
Mileage 28,397
Installed two (2) AGWEPS side by side
Four (4) cylinder engine (outer spark plugs)
Half driving Day time average temp 83 degree
Half driving Night time average temp 78 degree
City/Highway/Mountain Driving
Identical Driven Path Twice to and from, different Temperature times of the day (Day & Night)
Air Conditioner on all the time.
Definitely More Power Going Up Hill.
Driving Percent (50% City)(25% Hwy)(25% Mtn)
82.5 Total Miles Driven (to and from)
2.22 Gallons used
MPG with AGWEPS: 37.16
Compare with Auto Dealership New Sticker (City 24)(Hwy 30)

Test Results 2:
2004 VW Jetta
Date May 29, 2006
Mileage 28,502
Installed (1) One AGWEPS Per Spark Plug Wire
Finished the identical Test as above. Weather Temp's are identical. Air Conditioner on all the time.
83.3 Miles Driven (to and From)
2.215 Gallons used
MPG with AGWEPS: 37.60
Compare With Auto Dealership New Stick (City 24) (Hwy 30)

Test Results 3:
1999 BMW 528i
Date: Jun. 1, 2006
Mileage 58,226
Installed One (1) AGWEPS (Inner spark plugs) six (6) cylinder engine
Half driving Day time average temp 82 degree
Half driving Night time average temp 76 degree
City/Highway/Mountain Driving
Identical Driven Path Twice to and from, different Temperature times of the day (Day & Night)
Driving Percent (50% City)(25% Hwy)(25% Mtn)
83.8 Total Miles Driven (to and from)
2.31 Gallons used
MPG with AGWEPS: 36.28
Compare with Auto Dealership New Sticker (City 16)(Hwy 22).

The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without resorting to the details specifically set forth. In other instances, well known processing structures have not been described in detail, in order not to unnecessarily obscure the present invention.

Only an exemplary embodiment of the present invention and but a few examples of its versatility are shown and described in the present disclosure. It is to be understood that the present invention is capable of use in various other combinations and environments and is capable of changes or modifications within the scope of the inventive concept as expressed herein. For example, the attaching of an AGWEPS device to a power wire of an engine has been described only in terms of performing the attachment after that power wire has already been installed in the engine. One of ordinary skill would readily recognize that power wires may be manufactured in such a way that includes attaching one or more AGWEPS to the power wire during the manufacturing process of the power wire or, at least, before the power wire is first installed in an engine. In this way, an owner of an engine may elect to install one or more AGWEPS devices on conventional power wires already installed in an engine or simply install, or replace existing power wires, with power wires in which one or more AGWEPS devices are already incorporated.

What is claimed:

1. A method for modifying an internal combustion engine comprising the step of:
attaching a first non-magnetic, piezo-ceramic device to a power wire of the engine.

2. The method of claim 1, wherein the first device is attached to an external surface of insulation surrounding a portion of the power wire.

3. The method of claim 1, wherein the power wire comprises a first end terminating near a combustion chamber of the engine and a second end terminating near a source of electrical energy.

4. The method of claim 3, wherein the first device is attached to the power wire closer to the first end than to the second end.

5. The method of claim 4, wherein the first device is attached substantially adjacent the first end.

6. The method of claim 4, wherein the first device is attached to the power wire at a range of approximately 3 to 6 inches from the first end.

7. The method of claim 1, further comprising the step of:
attaching a second non-magnetic, piezo-ceramic device to the power wire of the engine.

8. The method of claim 7, wherein the second device is attached to the power wire substantially adjacent the first device.

9. The method of claim 1, wherein the engine includes multiple cylinders each having a respective power wire.

10. The method of claim 9, further comprising the step of:
attaching a respective non-magnetic, piezo-ceramic device to each of the respective power wires.

11. The method of claim 1, wherein the first end of the power wire is adapted to be coupled with an external spark plug.

12. The method of claim 1, wherein the first end of the power wire is adapted to be coupled with an internal spark plug.

13. The method of claim 1, wherein the first end of the power wire is adapted to be coupled with a glow plug.

14. The method of claim 1, wherein the first device is constructed of a dipolar material aligned along a major axis of the device.

15. The method of claim 14, further comprising the step of:
before attaching the first device, orienting the first device so that the major axis is substantially aligned with the power wire.

16. The method of claim 15, wherein the step of orienting includes the step of:
positioning the first device such that a positive pole of the dipolar material is located closer to the second end of the power wire than to the first end.

17. The method of claim 1, wherein the first device is releasably attached to the power wire.

18. A method of reducing emissions from an internal combustion engine comprising the step of:
attaching a first non-magnetic, piezo-ceramic device to a power wire of the engine.

19. The method of claim 18, wherein the power wire comprises a first end terminating near a combustion chamber of the engine and a second end terminating near a source of electrical energy.

20. The method of claim 18, wherein the first device directs acoustical energy along the power wire in a direction from the second end to the first end.

21. The method of claim 20, wherein the acoustical energy is directed to a combustion chamber associated with the power wire.

22. The method of claim 21, wherein the acoustical energy ionizes at least a portion of any fuel within the combustion chamber.

23. The method of claim 18, further comprising the step of:
attaching a second non-magnetic, piezo-ceramic device to the power wire of the engine.

24. The method of claim 18, wherein the engine includes multiple cylinders each having a respective power wire.

25. The method of claim 24, further comprising the step of:
attaching a respective non-magnetic, piezo-ceramic device to each of the respective power wires.

26. A method of increasing efficiency of an internal combustion engine comprising the step of:
attaching a first non-magnetic, piezo-ceramic device to a power wire of the engine.

27. The method of claim 26, wherein the power wire comprises a first end terminating near a combustion chamber of the engine and a second end terminating near a source of electrical energy.

28. The method of claim 26, wherein the first device directs acoustical energy along the power wire in a direction from the second end to the first end.

29. The method of claim 28, wherein the acoustical energy is directed to a combustion chamber associated with the power wire.

30. The method of claim 29, wherein the acoustical energy ionizes at least a portion of any fuel within the combustion chamber.

31. The method of claim 30, wherein the acoustical energy applies a force on a piston in the combustion chamber in a direction in which the piston generates power for the engine.

32. The method of claim 26, further comprising the step of:
attaching a second non-magnetic, piezo-ceramic device to the power wire of the engine.

33. The method of claim 26, wherein the engine includes multiple cylinders each having a respective power wire.

34. The method of claim 33, further comprising the step of:
attaching a respective non-magnetic, piezo-ceramic device to each of the respective power wires.

35. A method of manufacturing a device comprising the steps of:
shaping a non-magnetic, piezo-ceramic material into a shape having a first end, a second end and a major axis between the first end and the second end; and
affixing a diode between the first end and the second end.

36. The method of claim 35, further comprising the steps of:
forming, respectively, an electrically conducting surface on the first end and the second end; and
affixing a first terminal of the diode to the first electrically conducting surface and affixing a second terminal of the diode to the second electrically conducting surface.

37. The method of claim 35, wherein the diode is external to the non-magnetic, piezo-ceramic material.

38. The method of claim 35, further comprising the steps of:
softening the non-magnetic, piezo-ceramic material by heating; and
inserting the diode within the softened material such that a first terminal of the diode is substantially adjacent the first end and a second terminal of the diode is substantially adjacent the second end.

39. The method of claim 38, further comprising the steps of:
forming a first electrically conductive surface on an exterior of the material that is electrically coupled to the first terminal of the diode; and
forming a second electrically conductive surface on the exterior of the material that is electrically coupled to the second terminal of the diode.

40. The method of claim 35, further comprising the step of:
affixing another diode between the first end and the second end.

41. The method of claim 40, wherein one of the diode and the another diode is external to the material and the other of the diode and the another diode is internal to the material.

42. A device adapted for connection to a power wire of an internal combustion engine, the device comprising:
a slug of non-magnetic, piezo-electric material, the slug having a first end, a second end, and a major axis running between the first end and the second end; and
a first diode having a first terminal electrically coupled to the first end of the slug and a second terminal electrically coupled to the second end of the slug.

43. The device of claim 42, further comprising:
a second diode having a third terminal electrically coupled to the first end of the slug and a fourth terminal electrically coupled to the second end of the slug.

44. The device of claim 42, wherein the slug is substantially cylindrical in shape.

45. The device of claim 42, wherein the slug is substantially rectangular in shape.

46. The device of claim 42, wherein a surface of the slug is shaped so as to conform to an exterior shape of the power wire.

47. The device of claim 42, wherein the power wire comprises a first end terminating near a combustion chamber of the engine and a second end terminating near a source of electrical energy.

48. The device of claim 47, wherein the first end of the power wire is adapted to be coupled with an external spark plug.

49. The device of claim 47, wherein the first end of the power wire is adapted to be coupled with an internal spark plug.

50. The device of claim 47, wherein the first end of the power wire is adapted to be coupled with a glow plug.

51. The device of claim 42, wherein the slug is constructed of a dipolar material aligned along its major axis.

52. A power wire for an internal combustion engine, comprising:
a first end adapted to terminate near a combustion chamber of the engine and a second end adapted to terminate near a source of electrical energy; and
a first non-magnetic, piezo-ceramic device attached to an exterior of the power wire.

53. The power wire of claim 52, further comprising:
a second non-magnetic, piezo-ceramic device attached to the exterior of the power wire.

54. The power wire of claim 53, wherein the second device is located substantially adjacent the first device.

55. The power wire of claim 52, wherein the first device is attached to the power wire closer to the first end than to the second end.

56. The power wire of claim 55, wherein the first device is attached substantially adjacent the first end.

57. The power wire of claim 56, wherein the first device is attached to the power wire at a range of approximately 3 to 6 inches from the first end.

58. The power wire of claim 52, wherein the first device is constructed of a dipolar material aligned along a major axis of the device.

59. The power wire of claim 58 wherein the first device is oriented so that the major axis is substantially aligned with the power wire.

60. The power wire of claim 59, wherein the first device is positioned such that a positive pole of the dipolar material is located closer to the second end of the power wire than to the first end.

61. The power wire of claim 52, wherein the first device is releasably attached to the power wire.

62. The device of claim 42, wherein the slug comprises lead, graphite and at least one material selected from the group of zirconium, titanium, and strontium.

63. The device of claim 42, wherein the slug comprises zirconium and graphite.

64. The device of claim 42, wherein the slug comprises lead oxide.

65. The device of claim 42, wherein the slug comprises less than approximately 3% carbon black graphite.

66. The device of claim 42, wherein the slug comprises less than approximately 11% strontium oxide.

67. The device of claim 42, wherein the slug comprises less than approximately 31% titanium dioxide.

68. The device of claim 42, wherein the slug comprises less than approximately 36% zirconium dioxide.

69. The device of claim 42, wherein the slug comprises between 50-80% lead oxide.
